(19) United States
(12) Patent Application Publication
(10) Pub. No.: US 2018/0105415 A1
(43) Pub. Date: Apr. 19, 2018

(54) FUEL NOZZLE WITH ENHANCED TIP

(71) Applicant: Gilbarco Inc., Greensboro, NC (US)

(72) Inventors: Jesse Devon Juday, Oak Ridge, NC (US); Thor Michael Smith, Greensboro, NC (US); William Ralph Stone, JR., Oak Ridge, NC (US)

(21) Appl. No.: 15/785,129

(22) Filed: Oct. 16, 2017

Related U.S. Application Data
(60) Provisional application No. 62/409,193, filed on Oct. 17, 2016.

(51) Int. Cl. B67D 7/42; B67D 7/48

(52) U.S. Cl. CPC B67D 7/421; B67D 7/48

(57) ABSTRACT

A fuel nozzle is provided including a fuel spout configured to dispense fuel and an enhanced tip disposed at a dispensing end of the fuel spout, the enhanced tip comprising a generally smooth exposed surface configured to limit abrasion of materials contacted by the dispensing end of the fuel spout.

### PRIORITY CLAIM

This application is based upon and claims priority to provisional application Ser. No. 62/409,193, filed Oct. 17, 2016, which is relied upon and incorporated herein by reference in its entirety.

### BACKGROUND

The present invention relates generally to equipment used in fuel dispensing environments. More specifically, embodiments of the present invention relate to a fuel nozzle with an enhanced tip for use with a fuel dispenser.

Fuel dispensing facilities are in widespread use, providing customers with liquid fuel for various applications. A common fueling transaction, where fuel is dispensed into a vehicle fuel tank, typically proceeds as follows: (1) The customer indicates to the fuel dispenser the type of fuel desired and a payment method. (2) The fuel dispenser authorizes payment and energizes a pump which pumps fuel to the nozzle (or opens a valve via which pressurized fuel is supplied). (3) The customer places the fuel nozzle into the vehicle fuel tank and pulls the handle of the nozzle to open a manually-actuated valve and dispense the desired amount of fuel.

In some instances the customer may unintentionally contact the end of the fuel nozzle with the exterior of the vehicle, which may cause an abrasion, such as a scratch or gouge in the paint. In another example, the customer may use the fuel nozzle as an extension of their hand for interaction with a customer interface, such as selecting a fuel grade, pushing soft buttons, or interacting with a touch screen on the fuel dispenser. The use of the fuel nozzle to interact with a customer interface of the fuel dispenser may cause abrasions of the customer display, which may be unsightly or inhibit functionality, such as in the case of the touch screen.

### SUMMARY

The present invention recognizes and addresses various considerations of prior art constructions and methods. According to one aspect, the present invention provides a fuel nozzle including a fuel spout configured to dispense fuel and an enhanced tip disposed at a dispensing end of the fuel spout, the enhanced tip comprising a generally smooth exposed surface configured to limit abrasion of materials contacted by the dispensing end of the fuel spout.

### BRIEF DESCRIPTION OF THE DRAWINGS

A full and enabling disclosure of the present invention, including the best mode thereof directed to one skilled in the art, is set forth in the specification, which makes reference to the appended drawings, in which:

FIG. 1 illustrates a perspective view of an example fuel dispenser in accordance with an embodiment of the present invention.

FIG. 2 shows a cross-sectional view of a fuel dispensing nozzle in accordance with an embodiment of the present invention.

FIG. 3 illustrates a customer interface of a fuel dispenser in accordance with an embodiment of the present invention.

FIG. 4 illustrates a perspective view of a fuel nozzle with an enhanced tip in accordance with an embodiment of the present invention.

FIG. 5 illustrates an enhanced tip in accordance with an embodiment of the present invention.

FIGS. 6A-6C illustrate a fuel spout with an enhanced tip and a sensing port in accordance with example embodiments of the present invention.

FIGS. 7A-7C illustrate a cross-section of a fuel spout with an enhanced tip in accordance with example embodiments of the present invention.

### DETAILED DESCRIPTION OF PREFERRED EMBODIMENTS

Reference will now be made in detail to presently preferred embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the present disclosure including the appended claims and their equivalents.

A fuel nozzle may be provided including an enhanced tip at the end of the fuel spout. The enhanced tip may be generally smooth and/or include a rounded perimeter to limit or prevent abrasion of materials that the end of the fuel nozzle contacts, such as a fuel dispenser touch screen, a customer's vehicle, or the like.

In some embodiments, the enhanced tip may be configured to allow or promote use of the fuel nozzle as a touch screen stylus. For example, the enhanced tip may be formed of a non-dielectric (e.g., conductive) material, such as conductive silicone rubber. Alternatively, the enhanced tip may be configured to dissuade or limit use of the fuel nozzle to actuate the touch screen. For example, the enhanced tip may be formed of a dielectric (e.g., non-conductive) material, such as rigid plastic, non-conductive rubber, or the like.

The enhanced tip may be affixed to the end of the fuel nozzle by various methods including, without limitation, snap tabs, adhesive, interference fit, and complementary threads. In some example embodiments, the enhanced tip is configured to accommodate an overfill or maximum fill sensing port.

Some embodiments of the present invention may be particularly suitable for use with a fuel dispenser in a retail service station environment, and the below discussion will describe some preferred embodiments in that context. However, those of skill in the art will understand that the present invention is not so limited. In fact, it is contemplated that embodiments of the present invention may be used with any fluid dispensing environment and with other fluid dispensers. For example, embodiments of the present invention may also be used with diesel exhaust fluid (DEF) dispensers, compressed natural gas (CNG) dispensers, and liquefied petroleum gas (LPG) and liquid natural gas (LNG) applications, among others.

### Example Fuel Dispenser

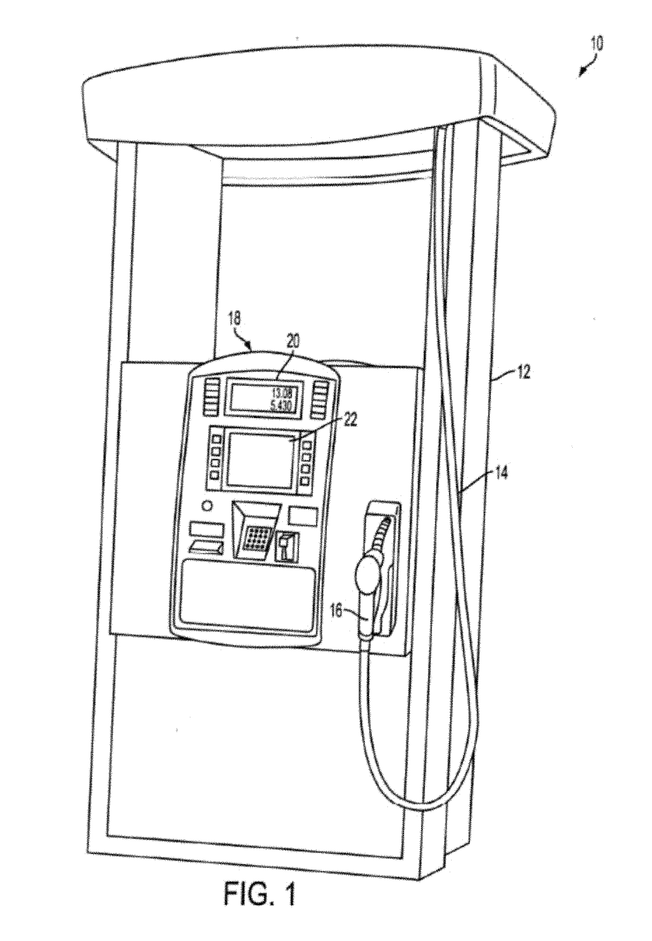

FIG. 1 is a perspective view of an exemplary fuel dispenser 10 according to an embodiment of the present invention. Fuel dispenser 10 may include a housing 12 with a flexible fuel hose 14 extending therefrom, which in this exemplary case is a coaxial fuel hose for vapor recovery. Fuel hose 14 may terminate in a manually-operated fuel nozzle 16 adapted to be inserted into a fill neck of a vehicle's fuel tank. Fuel nozzle 16 typically includes a fuel valve, which is opened via a handle. Various fuel handling components, such as valves and meters, may also located inside of housing 12. These fuel handling components may allow fuel to be received from underground piping and delivered through fuel hose 14 and fuel nozzle 16 to a vehicle's fuel system, e.g. fuel tank.

Fuel dispenser 10 may include a customer interface 18. Customer interface 18 may include an information display 20 relating to an ongoing fueling transaction that shows the amount of fuel dispensed and the price of the dispensed fuel. Further, customer interface 18 may include a display 22 that provides instructions to the customer regarding the fueling transaction. Display 22 may also provide advertising, merchandising, and multimedia presentations to a customer, and may allow the customer to purchase goods and services other than fuel at the dispenser.

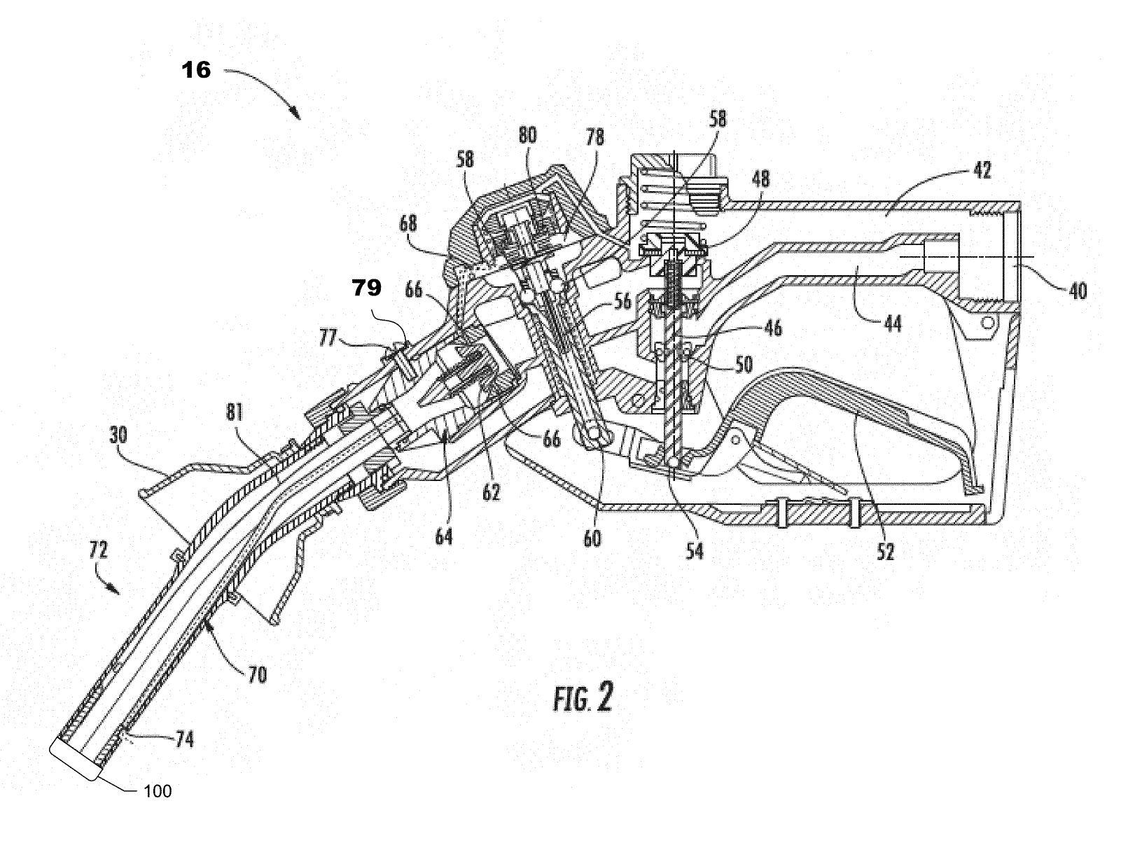

FIG. 2 shows a cross-sectional view of an exemplary fuel nozzle 16. The nozzle 16 may include an inlet port 40 that receives the fuel hose 14, such that an inner conduit of the fuel hose 14 may be in fluid communication with the main fluid path 42 and the outer conduit may be in fluid communication with the vapor recovery line 44. The main valve stem 46 may be configured to open and close a main fluid valve 48 and a main vapor recovery valve 50.

The main valve stem 46 may be spring-biased in a closed position (i.e., downward) and may be pivotally connected to the lever arm (handle) 52 at the intermediate pivot 54. During a normal dispensing event, plunger 56 of the nozzle's shut-off mechanism may be locked in a retracted position by metallic balls 58. As a result, plunger pin 60 may act as a fulcrum for lever arm 52. Therefore, when a customer pulls up on lever arm 52, main valve stem 46 may simultaneously open both the main fluid valve 48 and the main vapor recovery valve 50. Opening the main fluid valve 48 may allow fuel to flow through the main fluid path 42. A vapor recovery path may begin at the nozzle spout 72, where air and vapor are drawn in through a boot 30 or a series of intake ports. The recovered vapors may then flow through the fuel nozzle 16 to a vapor recovery conduit of the fuel hose 14.

The flowing fuel may create sufficient pressure to open poppet valve 62 and may allow fuel to flow through the spout housing 64. As fuel flows through the poppet valve 62 and past venturi channels 66, a vacuum may be created in the venturi-generated vacuum chamber 68. The vacuum chamber 68 may be connected to a vacuum sensing tube 70 that extends to the tip of the nozzle spout 72. The vacuum sensing tube 70 may draw in air and vapor through a sensing port 74 near the tip of the nozzle spout 72 as the fuel flows out of the nozzle 16. Although the depicted example embodiment includes a venturi as the mechanism creating a vacuum in the vacuum sensing chamber 68, other suitable methods for creating a vacuum may be used.

The fuel nozzle may include a shutoff mechanism configured to close the fuel dispensing and vapor recovery valves when certain conditions occur. These shutoff mechanisms may rely on changes in the vacuum generated in the venturi-generated vacuum chamber 68 as a trigger. In an example embodiment, the shutoff mechanism may operate by releasing the main valve stem 46 and thus closing the main fluid valve 48 and main vapor recovery valve 50 when the vacuum sensing path is blocked. When the pressure drops in the venturi-generated vacuum chamber 68, a diaphragm 78 may pop up against the force of a spring 80 and allows metallic balls 58 to retract from receiving notches in a plunger 56. The plunger 56 may be spring-biased, such that when the metallic balls 58 are removed, the plunger 56 may be driven downward, thus releasing the plunger pin 60 and lowering the fulcrum point of lever 52. In response to the plunger pin 60 being released, the spring on the spring-biased main valve stem 46 may close the main fluid valve 48 and main vapor recovery valve 50.

The shutoff mechanism may be configured to be triggered when various conditions occur. For example, the shutoff mechanism may be configured to stop the flow of fuel when the vehicle's fuel tank is full. Specifically, when the fuel level in the tank reaches the tip of the fuel nozzle 16, the fuel blocks the sensing port 74 of the vacuum sensing tube 70 and may cause the shutoff mechanism to stop the flow of fuel as described above.

In an example embodiment, the spout housing 64 may connect the main body of the fuel nozzle 16 to the nozzle spout 72. In this regard, the spout housing 64 may be received in a configured pocket defined in the main body of the fuel nozzle 16. As shown in FIG. 2, the spout housing 64 may be retained in the pocket via one or more retaining screws 77. Screws 77 may engage a threaded hole 79 defined in the outer surface of spout housing 64. Spout housing 64 may connect the main fluid path 42 to the fuel output tube 81 and connects the vacuum sensing tube 70 with the venturi-generated vacuum chamber 68.

The fuel nozzle 16 may include an enhanced tip 100 disposed at the dispensing end of the fuel spout 72. The enhanced tip 100 may include a generally smooth exposed surface configured to limit abrasion of materials contacted by the dispensing end of the fuel spout 72, such as components of the customer interface 18, customer vehicle, or the like. In some example embodiments, the enhanced tip may be configured to fit into a vehicle fuel port. In this regard, the outer diameter of enhanced tip 100 may preferably be equal to or less than an outer diameter of the fuel spout 72 to prevent physical interference with the vehicle's fill neck. Example embodiments of the enhanced tip 100 are described in further detail below in reference to FIGS. 4-6C.

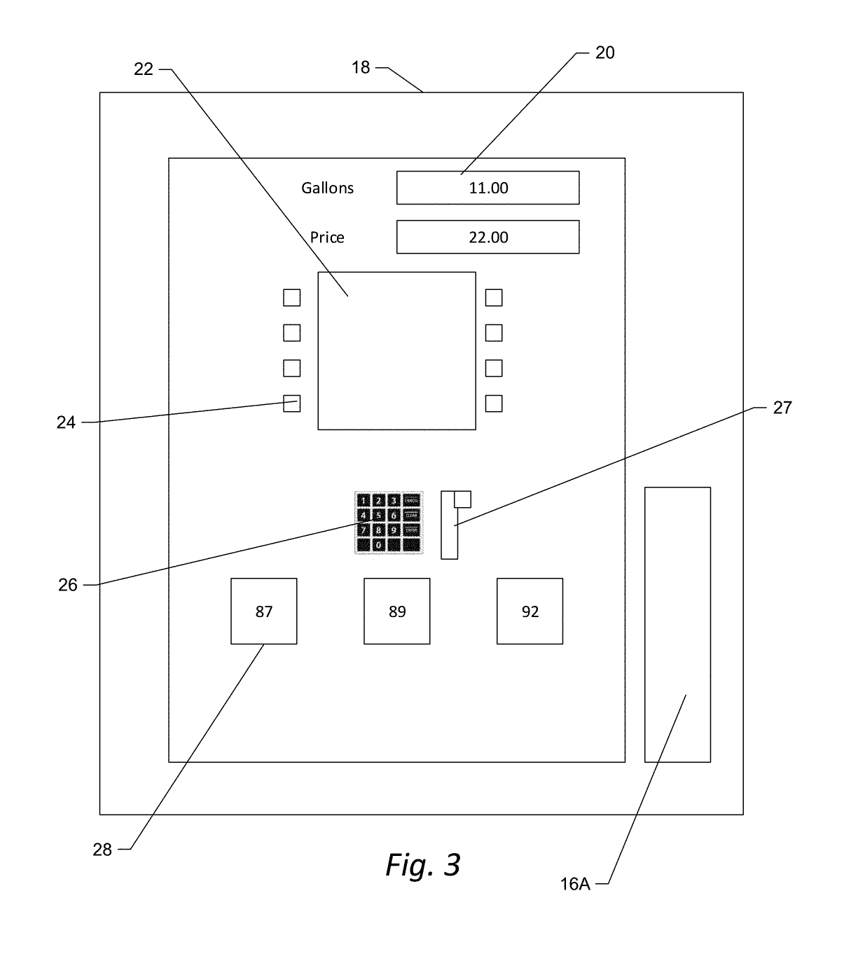

FIG. 3 illustrates a customer interface 18 in accordance with an embodiment of the present invention. As discussed above in reference to FIG. 1, the customer interface 18 may include the information display 20 and display 22. The information display 20 may display a volume, e.g. gallons or liters, of fuel dispensed, total price of the fuel dispensed, a per unit price, or the like. In addition to operational instructions, the display 22 may variously display advertising, merchandising, and multimedia presentations, or the like. In some instances, the display 22 may display selection prompts, such as solicitation for goods or services, for example a car wash or a promotional item. A customer may respond to the selection prompt by depressing one or more soft buttons 24, or in an instance in which the display 22 is a touch screen, touching an appropriate portion of the display 22 itself.

The customer interface 18 may also include a personal identification number (PIN) pad 26, to receive numerical information associated with a payment, such as a debit card PIN, a postal (“zip”) code, or the like, along with a card reader 27. The customer interface 18 may include one or more fuel grade selectors 28 for selecting a grade or type of fuel. The customer interface may also include a nozzle cradle 16A configured to retain the fuel nozzle 16, when the fuel nozzle 16 is not in use. The display 22, soft buttons 24, PIN pad 26, fuel grade selectors 28, or the like may be configured to be operated by the customer, such as by using a finger.

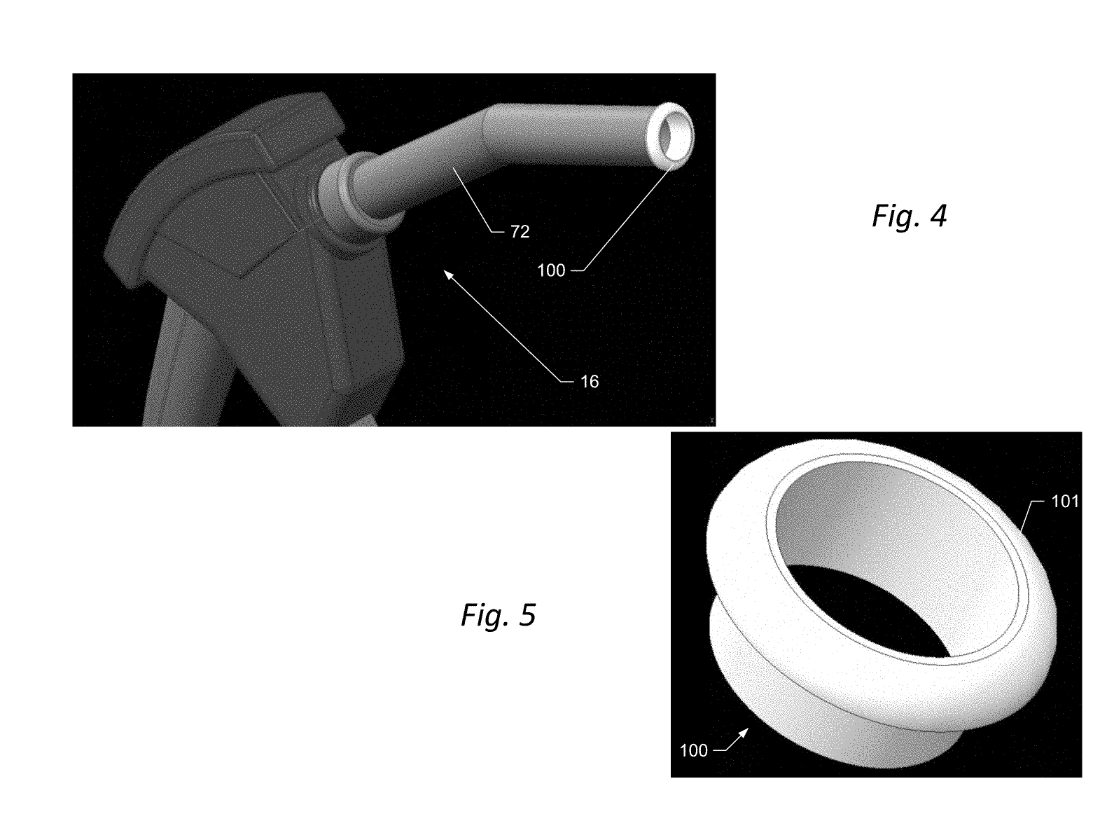

FIG. 4 illustrates a perspective view of a fuel nozzle 16 with a enhanced tip 100 in accordance with an embodiment of the present invention. FIG. 5 illustrates an enhanced tip 100 in one embodiment removed from the nozzle 16. As shown, the enhanced tip 100 may be disposed at the dispensing end of the fuel spout 72, and define a generally smooth exposed surface 101. The exposed surface 101 may be configured to limit abrasion of materials contacted by the dispensing end of the fuel spout, such as the display 22, soft buttons 24, fuel grade selectors 28, a customer vehicle, or the like. In some embodiments, the exposed surface 101 may include a rounded edge at an outer perimeter, configured to further limit abrasions. The enhanced tip 100 may be resistant to degradation from fuel exposure, e.g., capable of six months or more of fueling operations without a significant change in fracture toughness, chemical etching, or the like.

In an example embodiment, the enhanced tip 100 may be configured for use as a touch screen stylus, such as a stylus for interaction with display 22. In an embodiment in which the enhanced tip 100 is configured to be used as a touch screen stylus, the enhanced tip 100 may be formed from a non-dielectric (e.g., conductive) material. The non-dielectric material may be capacitance inductive, such as conductive silicone rubber, which may be sensed by one or more capacitive sensors of the display 22. In this case, the customer may use the enhanced tip 100 to make selection on the touch screen of display 22, but without damaging the display.

Alternatively, the enhanced tip 100 may be configured to dissuade or limit use of the dispensing end of the fuel spout to actuate a touch screen of the display 22. For example, the enhanced tip, may be formed from a dielectric (i.e., non-conductive) material, such as a rigid plastic, non-conductive rubber, or the like. In this case, the capacitive sensors of the display 22 may not detect a change in capacitance when the dispensing end of the fuel spout is used in an attempt to make a selection on display 22.

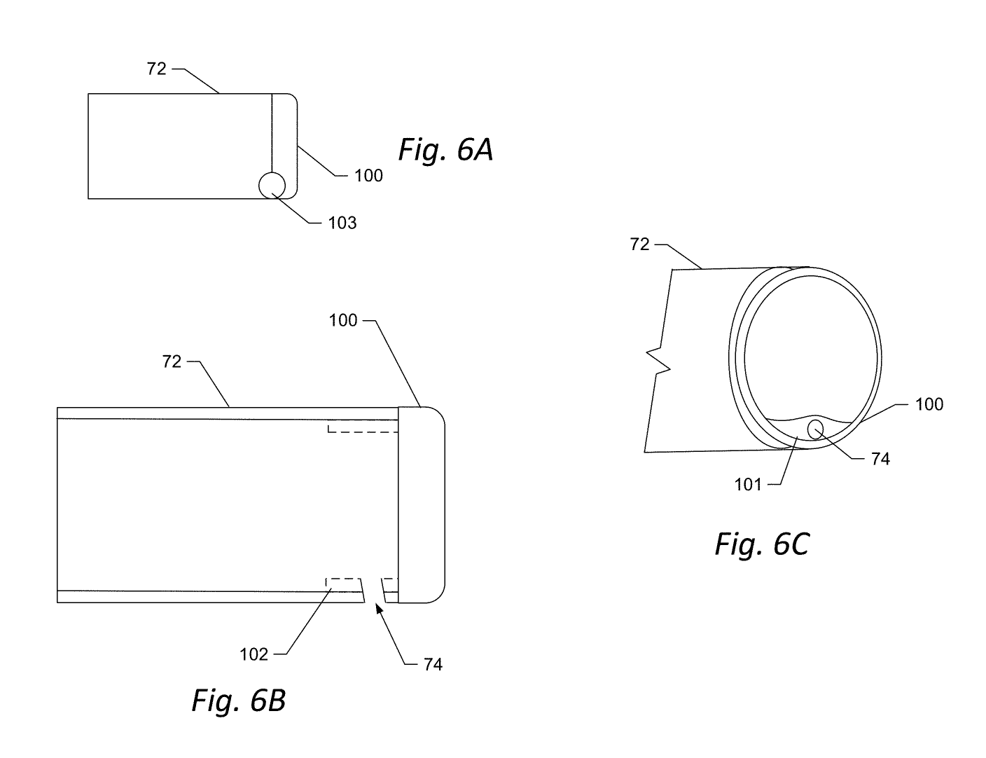

FIGS. 6A-6C illustrates fuel spout 72 with an enhanced tip 100 and a sensing port in accordance with example embodiments of the present invention. In the example embodiment depicted in FIG. 6A, a first portion of the sensing port (e.g., a first half) is disposed in the fuel spout 72 and a second portion of the sensing port (e.g., a second half) is disposed in the enhanced tip 100, such that when the enhanced tip 100 is connected or affixed to the dispensing end of the fuel spout 72 a sensing port 103 is formed at an interface between the fuel spout and the enhanced tip 100.

In the example depicted in FIG. 6B, the enhanced tip 100 may include connector sidewall 102 which is disposed within the dispensing end of the fuel spout 72. (One skilled in the art will appreciate that sidewall 102 will often be annular such that it follows and engages the inner diameter of spout 72.) The sensing port 74 may be disposed in a sidewall of the fuel spout 72. In this embodiment, the sensing port 74 may be disposed, such that the sensing port extends through both the fuel spout 72 and an aligned aperture defined in the connector sidewall 102.

In the example embodiment depicted in FIG. 6C, the sensing tube 70 may extend to the dispensing end of the fuel spout 72. The sensing port 74 may be disposed in the enhanced tip 100 so as to be axially aligned with the end of the sensing tube 70. The sensing port 74 therefore acts as an extension of the sensing tube 70 from the dispensing end of the fuel spout 72 to the exposed surface 101 of the enhanced tip 100.

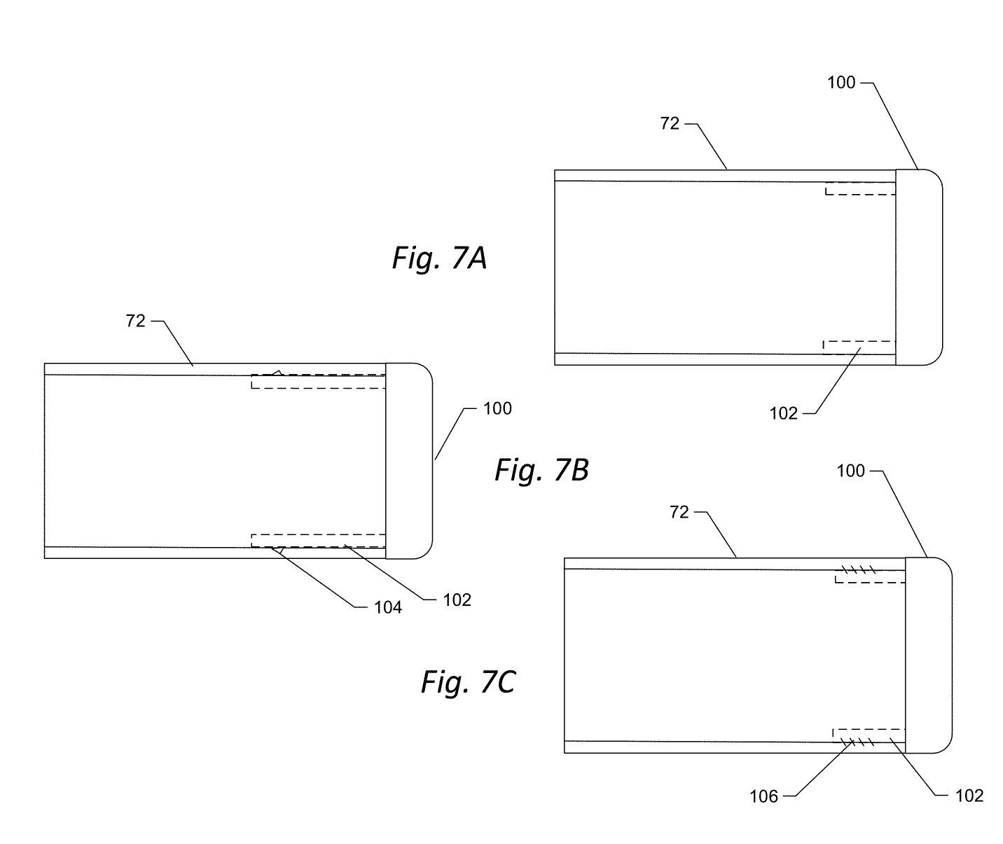

FIGS. 7A-7C illustrate a cross-section of a fuel spout 72 with an enhanced tip 100 in accordance with example embodiments of the present invention. The enhanced tip 100 may be affixed to the dispensing end of the fuel spout 72 by various methods. FIG. 7A illustrates an example embodiment, in which the connector sidewall 102 extends into the dispensing end of the fuel spout 72. The enhanced tip 100 may be affixed to the fuel spout 72 by adhesive, such as an epoxy, by an interference fit, e.g., a press fit, or the like.

In some example embodiments, such as depicted in FIG. 7B, the connector sidewall 102 may include a retention projection 104 and the fuel spout 72 may include a retention recess configured to receive the retention projection 104. The enhanced tip 100 may be affixed to the fuel spout 72 by the retention projection engaging the retention recess. Additionally or alternatively, the fuel spout 72 may include the retention projection 104 and the connector sidewall 102 of the enhanced tip 100 may include the retention recess.

In some example embodiments, the connector sidewall 102 may be segmented into two or more snap tabs. The snap tabs may flex inward when inserted into the fuel spout 72 generating a biasing force against the sidewall of the fuel spout 72. In some example embodiments, one or more of the snap tabs may include the retention projections 104 and/or the retention recesses, as described above.

In the example embodiment, depicted in FIG. 7C, the connector sidewall 102 and the inner wall of the fuel spout 72 may include complementary threads 106. The complementary threads 106 may allow the enhanced tip 100 to be screwed into the dispensing end of the fuel spout, thus affixing the enhanced tip 100 to the fuel spout 72.

In some example embodiments, the fuel nozzle may be further configured for additional operations or optional modifications. In this regard, in an example embodiment, the enhanced tip is configured to be used as a touch screen stylus. In an example embodiment, the enhanced tip includes a non-dielectric material. In some example embodiments, the enhanced tip includes conductive silicone rubber or another suitable conductive material. In an example embodiment, the enhanced tip is configured to limit use of the dispensing end of the fuel nozzle to actuate a touch screen. In some example embodiments, the enhanced tip includes a dielectric material. In an example embodiment, the enhanced tip includes a rigid plastic. In some example embodiments, the enhanced tip includes a non-conductive rubber. In an example embodiment, the enhanced tip is resistant to fuel degradation. In some example embodiments, the fuel nozzle also includes a sensing port configured to sense a fuel level at the dispensing end of the fuel spout to limit overfilling of a fuel container. In an example embodiment, the sensing port is disposed in a side wall of the fuel spout. In some example embodiments, the sensing port is disposed through the fuel spout and the enhanced tip. In an example embodiment, a first portion of the sensing port is disposed in the fuel spout and a second portion of the sensing port is disposed in the enhanced tip. In some example embodiments, the sensing port extends through the enhanced tip in the direction of extension of the fuel spout. In an example embodiment, the enhanced tip includes a rounded edge at an outer perimeter of the exposed surface. In some example embodiments, the enhanced tip is affixed to the dispensing end of the fuel spout. In an example embodiment, at least a portion of the enhanced tip extends into the dispensing end of the fuel spout. In some example embodiments, the enhanced tip is affixed to the dispensing end of the fuel spout by a snap tab. In an example embodiment, the enhanced tip is affixed to the dispensing end of the fuel spout by an interference fit. In some example embodiments, the enhanced tip is affixed to the dispensing end of the fuel spout by complementary threads. In an example embodiment, the enhanced tip is affixed to the dispensing end of the fuel spout by an adhesive. In some example embodiments, the enhanced tip or fuel spout includes at least one retention projection and the other of the enhanced tip or the fuel spout includes at least one retention recess and the enhanced tip is affixed to the fuel spout by an engagement of the at least one retention projection and the at least one retention recess.

One skilled in the art will be able to identify suitable materials from which to form enhanced tip 100, such as suitable polymeric or elastomeric materials. The material chosen should have adequate resistance to degradation in the presence of the liquid being dispensed. Enhanced tip 100 may be formed of any suitable process such as injection molding. One material that may be suitable for this purpose is known as Delrin 570 available from Ensinger.

Many modifications and other embodiments of the invention set forth herein will come to mind to one skilled in the art to which the invention pertains having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

What is claimed is:

1. A fuel nozzle comprising:
a fuel spout configured to dispense fuel; and
an enhanced tip disposed at a dispensing end of the fuel spout, the enhanced tip comprising a generally smooth exposed surface configured to limit abrasion of materials contacted by the dispensing end of the fuel spout.

2. The fuel nozzle of claim 1, wherein the enhanced tip is configured to be used as a touch screen stylus.

3. The fuel nozzle of claim 1, wherein the enhanced tip comprises a non-dielectric material.

4. The fuel nozzle of claim 1, wherein the enhanced tip comprises conductive silicone rubber.

5. The fuel nozzle of claim 1, wherein the enhanced tip is configured to limit use of the dispensing end of the fuel nozzle to actuate a touch screen.

6. The fuel nozzle of claim 1, wherein the enhanced tip comprises a dielectric material.

7. The fuel nozzle of claim 1, wherein the enhanced tip comprises a rigid plastic.

8. The fuel nozzle of claim 1, wherein the enhanced tip comprises a non-conductive rubber.

9. The fuel nozzle of claim 1, wherein the enhanced tip is resistant to fuel degradation.

10. The fuel nozzle of claim 1 further comprising:
a sensing port configured to sense a fuel level at the dispensing end of the fuel spout to limit overfilling of a fuel container.

11. The fuel nozzle of claim 10, wherein the sensing port is disposed in a side wall of the fuel spout.

12. The fuel nozzle of claim 10, wherein the sensing port is disposed through the fuel spout and the enhanced tip.

13. The fuel nozzle of claim 10, wherein a first portion of the sensing port is disposed in the fuel spout and a second portion of the sensing port is disposed in the enhanced tip.

14. The fuel nozzle of claim 10, wherein the sensing port extends through the enhanced tip in the direction of extension of the fuel spout.

15. The fuel nozzle of claim 1, wherein the enhanced tip comprises a rounded edge at an outer perimeter of the exposed surface.

16. The fuel nozzle of claim 1, wherein the enhanced tip is affixed to the dispensing end of the fuel spout.

17. The fuel nozzle of claim 1, wherein at least a portion of the enhanced tip extends in to the dispensing end of the fuel spout.

18. The fuel nozzle of claim 16, wherein the enhanced tip is affixed to the dispensing end of the fuel spout by a snap tab.

19. The fuel nozzle of claim 16, wherein the enhanced tip is affixed to the dispensing end of the fuel spout by an interference fit.

20. The fuel nozzle of claim 16, wherein the enhanced tip is affixed to the dispensing end of the fuel spout by complementary threads.

21. The fuel nozzle of claim 16, wherein the enhanced tip is affixed to the dispensing end of the fuel spout by an adhesive.

22. The fuel nozzle of claim 16, wherein one of the enhanced tip or fuel spout includes at least one retention projection and the other of the enhanced tip or the fuel spout includes at least one retention recess, and the enhanced tip is affixed to the fuel spout by an engagement of the at least one retention projection and the at least one retention recess.
